(19) United States
(12) Patent Application Publication
(10) Pub. No.: US 2019/0047252 A1
(43) Pub. Date: Feb. 14, 2019

(54) SMART GLASS-POLYMER ASSEMBLY, METHOD OF MANUFACTURE, AND SMART WINDOW

(71) Applicant: SABIC GLOBAL TECHNOLOGIES B.V., Bergen op Zoom (NL)

(72) Inventors: Ashok Sridhar, Bergen op Zoom (NL); Valerie Smits, Bergen op Zoom (NL)

(21) Appl. No.: 16/076,895

(22) PCT Filed: Feb. 8, 2017
(86) PCT No.: PCT/IB2017/050685

§ 371 Date: Aug. 9, 2018

Related U.S. Application Data
(60) Provisional application No. 62/294,524, filed on Feb. 12, 2016.

(51) Int. Cl. B32B 7/12; B32B 17/06; B32B 37/00; B32B 37/12

(52) U.S. Cl. CPC B32B 7/12; B32B 17/064; B32B 37/0053; B32B 2605/006; B32B 2307/412; B32B 2305/34; B32B 2457/20; B32B 37/12

(57) ABSTRACT

A method of manufacturing a smart glass-polymer assembly (10) includes providing an optically clear polymer film (12) comprising a thermoplastic polymer, and further having a first surface (14) and a second surface (16) opposite the first surface; disposing a smart functionality (18) onto the second surface of the optically clear polymer film; disposing a first side of an optically clear adhesive layer (20) onto at least a portion of the smart functionality and the second surface of the optically clear polymer film; and disposing a glass layer (26) onto a second side of the optically clear adhesive layer opposite the first side of the optically clear adhesive layer. At least one of the disposing steps is by roll-to-roll lamination. A smart glass-polymer assembly and smart window are also described.

### BACKGROUND

Windows for buildings and automobiles that can function as interfaces for human interaction and as nodes to for interaction with autonomous devices are often referred to as “smart windows.” Such windows can be an important component of the “internet of things” (IoT) framework. Some smart windows that can control light transmission though the window from the external environment are now commercially available. However, two significant limiting factors for large-scale commercial implementation of smart windows with advanced functionalities are: (1) the expense of integrating functionalities such as photovoltaics, displays, and transparent conductive electrodes for touch and communication antennas and the like; and (2) the challenge of protecting these functionalities from gas and moisture to improve reliability and service life. Ultra-thin barriers are available, but they have drawbacks arising from as end encapsulation, for example, especially when cut into required sizes from a standard roll. Thick glass barriers are available, but they add weight to the smart window.

Accordingly, there remains a continuing need in the art for an improved smart windows and methods of making smart windows.

### BRIEF DESCRIPTION

A method of manufacturing a smart glass-polymer assembly comprises providing an optically clear polymer film comprising a thermoplastic polymer, and further comprising a first surface and a second surface opposite the first surface; disposing a smart functionality and optionally wiring for the smart functionality onto the second surface of the optically clear polymer film; disposing a first side of an optically clear adhesive layer onto at least a portion of the smart functionality and the second surface of the optically clear polymer film; and disposing a glass layer onto a second side of the optically clear adhesive layer opposite the first side of the optically clear adhesive layer; wherein at least one of the disposing steps is by roll-to-roll lamination.

A smart glass-polymer assembly, comprises an optically clear polymer film comprising a thermoplastic polymer, and further comprising first surface and a second surface opposite the first surface; a smart functionality disposed on the second surface of the optically clear polymer film, optionally further comprising wiring for the smart functionality; an optically clear adhesive layer comprising a first side and a second side, wherein the first side is disposed on at least a portion of the smart functionality and the second surface of the optically clear polymer film; and a glass layer disposed on the second side of the optically clear adhesive layer.

The above-described and other features are exemplified by the following figures and detailed description.

### BRIEF DESCRIPTION OF THE DRAWINGS

The following figures are exemplary embodiments wherein the like elements are numbered alike.

FIG. 1 shows a cross sectional view of a smart glass-polymer assembly in accordance with an embodiment.

FIG. 2 shows a view of an embodiment of smart window viewed from the front of the window.

### DETAILED DESCRIPTION

The present inventors have discovered that a smart glass-polymer assembly can be manufactured by performing one or more of the steps in a roll-to-roll process. In a highly advantageous feature, all of the assembly steps can be performed in a roll-to-roll process. In particular, the smart glass-polymer assembly includes a smart functionality between a polymer layer and a glass layer. It can be produced by forming or depositing a smart functionality on an optically clear polymer film, applying an adhesive, and then applying a glass layer on the adhesive to encapsulate the functionality. Preferably, a support layer such as glass or a polycarbonate sheet can be disposed on a side of the optically clear polymer film opposite the glass layer, to enhance the structural strength of the laminate and to enhance the moisture and gas barrier properties of the laminate.

Smart glass-polymer assemblies as described herein are configured to have a property that can be altered in response to a signal, for example in response to a voltage, light, or heat. In some embodiments, the property is a transmission property. For example, in certain applications, a smart window comprising the smart glass-polymer assembly can change from translucent to transparent. When installed in buildings, for example, these smart windows can creative climate-adaptive building shells that can reduce the costs associated with heating, air conditioning, or lighting.

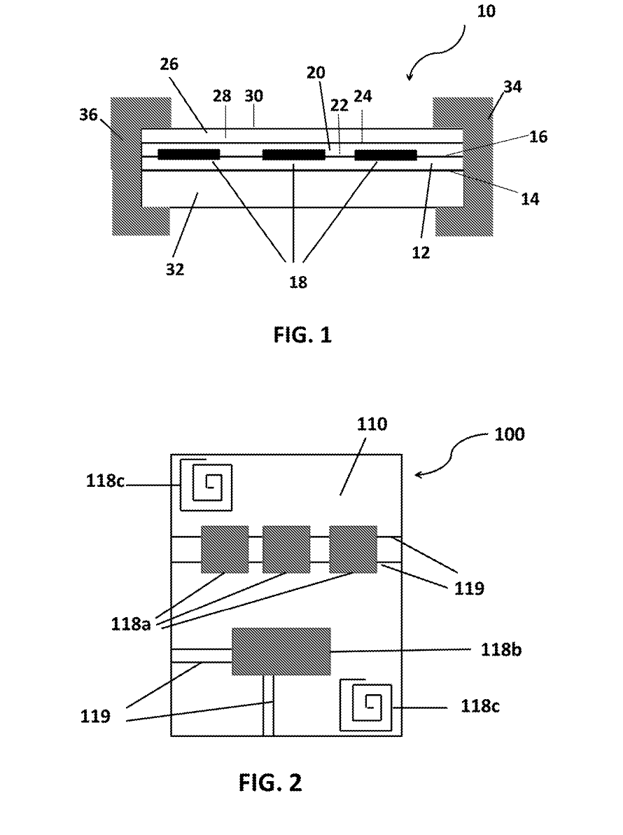

Accordingly, an aspect of the present disclosure is a smart glass-polymer assembly. As shown in FIG. 1, an embodiment of the smart glass-polymer assembly (10) comprises an optically clear polymer film (12) having a first surface (14) and a second surface (16) opposite the first surface. The second surface (16) of the optically clear polymer film (12) has disposed thereon one or more smart functionalities (18). Further disposed on the second surface (16) of the polymer film (12) is an adhesive layer (20) having a first side (22) and a second side (24) opposite the first side. The first side (22) is disposed at least partially on a smart functionality (18) and on the second surface (16) of the polymer film (12). In a preferred embodiment, the adhesive layer (20) completely covers each of the smart functionalities. In another preferred embodiment, the adhesive layer (20) completely covers each of the smart functionalities and the second surface (16) as shown in FIG. 1. Disposed on the second side (24) of the adhesive layer (20) is a glass layer (26) having a first surface (28) disposed on the adhesive layer (20) and a second surface (30) opposite the first surface.

A support layer (32) is optionally disposed on, for example laminated to, the first surface (14) of the polymer film (12). In some embodiments, an overmolded housing (34, 36) can be disposed over one or more of the edges of the smart glass-polymer assembly (10).

FIG. 2 shows a front view of an embodiment of a smart window (100) incorporating an embodiment of the smart glass-polymer assembly. The smart window (100) comprises an electrochromic smart glass-polymer assembly (110) comprising a plurality of photovoltaic smart functionalities (118a), a display functionality (118b), an antenna functionality (118c), and wires (119). In an operational smart window, all of the functionalities are connected to microcontrollers and ambient sensors (not shown in Figure). In a preferred embodiment, the display functionality (118b) has an in-built touch functionality for user interaction.

As described above, the smart glass-polymer assembly includes an optically clear polymer film. As used herein, the term “optically clear polymer film” means that a 100 micrometer-thick sample of the film transmits greater than 85% of visible light as determined according to ASTM D1003-00. In some embodiments, the optically clear polymer film can have a thickness of 1 micrometer to 20 millimeters, preferably 5 micrometers to 20 millimeters, more preferably 5 micrometers to 10 millimeters, even more preferably 5 micrometers to 1 millimeter, even more preferably still 5 to 250 micrometers, most preferably 5 to 100 micrometers.

The optically clear polymer film comprises a thermoplastic polymer. As used herein, the term “thermoplastic” refers to a material that is plastic or deformable, melts to a liquid when heated, and freezes to a brittle, glassy state when cooled sufficiently. Thermoplastics are typically high molecular weight polymers. Examples of thermoplastic polymers that can be used include polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones, polybenzothiazoles, polybenzoxazoles, polybenzimidazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units) polyolefins (e.g., polyethylenes, polypropylenes, polytetrafluoroethylenes, and their copolymers, for example ethylene-alpha-olefin copolymers), polyoxadiazoles, polyoxymethylene, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl nitriles, polyvinyl ketones, polyvinyl thioethers, polyvinylidene fluorides, or the like, or a combination comprising at least one of the foregoing thermoplastic polymers.

In some embodiments, the polymer film comprises a polyacetal, poly(C₁₋₆ alkyl)acrylate, polyarylate, polycarbonate, polyester, polyetherimide, polyimide, poly(C₁₋₆ alkyl)methacrylate, polyolefin, polystyrene, polyurethane, polyvinyl alcohol, polyvinyl ester, polyvinyl ether, polyvinyl halide, polyvinyl nitrile, polyvinyl ketone, polyvinylidene fluoride, or a combination comprising at least one of the foregoing thermoplastic polymers. In some embodiments, the polymer film comprises a polyimide, a polyetherimide, a polyester, a polyolefin, a polycarbonate, a (meth)acrylic polymer (e.g., poly(C₁₋₆ alkyl)acrylates, poly(C₁₋₆ alkyl)methacrylates, or a combination comprising at least one of the foregoing, preferably poly(methyl methacrylate)), a vinyl polymer, polyacetal (e.g., polyoxyethylene and polyoxymethylene), a styrenic polymer, or a combination comprising at least one of the foregoing. In some embodiments, the optically clear polymer film comprises a polyimide, a polyetherimide, a polyester, a polyolefin, a polycarbonate, or a combination comprising at least one of the foregoing. In some embodiments, the optically clear polymer film comprises poly(methyl methacrylate), a polycarbonate, or a combination comprising at least one of the foregoing.

In some embodiments, the optically clear polymer film can include a polycarbonate. Polycarbonates and their methods of manufacture are known in the art, being described, for example, in WO 2013/175448 A1, US 2014/0295363, and WO 2014/072923. “Polycarbonate” as used herein includes homopolymers and copolymers comprising different carbonate units or comprising carbonate units, for example ester units (“poly(ester-carbonate)s”, also known as polyester-polycarbonates.) Poly(ester-carbonate)s further contain, in addition to recurring carbonate units, repeating ester units derived from a dihydroxy compound (which includes a reactive derivative thereof), and can be, for example, a dihydroxy derivative of C₂₋₁₀ alkylene, a C₆₋₂₀ cycloalkylene a C₆₋₂₀ arylene, or a polyoxyalkylene group in which the alkylene groups contain 2 to 6 carbon atoms, specifically, 2, 3, or 4 carbon atoms; and a dicarboxylic acid (which includes a reactive derivative thereof), and can be, for example, a dicarboxy C₂₋₂₀ alkylene, a C₆₋₂₀ cycloalkylene, or a C₆₋₂₀ arylene. The polyester units can be branched or linear.

Specific dihydroxy compounds include aromatic dihydroxy compounds of formula (2) (e.g., resorcinol), bisphenols of formula (3) (e.g., bisphenol A), a C₁₋₈ aliphatic diol such as ethane diol, n-propane diol, i-propane diol, 1,4-butane diol, 1,6-cyclohexane diol, 1,6-hydroxymethylcyclohexane, or a combination comprising at least one of the foregoing dihydroxy compounds. Aliphatic dicarboxylic acids that can be used include C₆₋₂₀ aliphatic dicarboxylic acids, specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,6-cyclohexane dicarboxylic acid, or a combination comprising at least one of the foregoing acids. A combination of isophthalic acid and terephthalic acid wherein the weight ratio of isophthalic acid to terephthalic acid is 91:9 to 2:98 can be used.

Specific ester units include ethylene terephthalate units, n-proplyene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example 1:99 to 99:1, specifically, 10:90 to 90:10, more specifically, 25:75 to 75:25, or from 2:98 to 15:85. In some embodiments the molar ratio of ester units to carbonate units in the poly(ester-carbonate)s can vary from 1:99 to 30:70, specifically 2:98 to 25:75, more specifically 3:97 to 20:80, or from 5:95 to 15:85.

In a specific embodiment, the polycarbonate is a linear homopolymer containing bisphenol A carbonate units (BPA-PC), commercially available under the trade name LEXAN from SABIC; or a branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name LEXAN CFR from SABIC. A combination of a linear polycarbonate and a branched polycarbonate can be used. It is also possible to use a polycarbonate copolymer or interpolymer rather than a homopolymer. Polycarbonate copolymers can include copolycarbonates comprising two or more different types of carbonate units, for example units derived from BPA and PPPBP (commercially available under the trade name XHT from SABIC); BPA and DMBPC (commercially available under the trade name DMX from SABIC); or BPA and isophorone bisphenol (commercially available under the trade name APEC from Bayer). The polycarbonate copolymers can further comprise non-carbonate repeating units, for example repeating ester units (polyester-carbonates), such as those comprising resorcinol isophthalate and terephthalate units and bisphenol A carbonate units, such as those commercially available under the trade name LEXAN SLX from SABIC; bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units; or bisphenol A carbonate units and C₆₋₁₂ dicarboxy ester units such as sebacic ester units (commercially available under the trade name HFD from SABIC) Other polycarbonate copolymers can comprise repeating siloxane units (polycarbonate-siloxanes), for example those comprising bisphenol A carbonate units and siloxane units (e.g., blocks containing 5 to 200 dimethylsiloxane units), such as those commercially available under the trade name EXL from SABIC; or both ester units and siloxane units (polycarbonate-ester-siloxanes), for example those comprising bisphenol A carbonate units, isophthalate-terephthalate-bisphenol A ester units, and siloxane units (e.g., blocks containing 5 to 200 dimethylsiloxane units), such as those commercially available under the trade name FST from SABIC. Combinations of any of the above materials can be used.

Combinations of polycarbonates with other polymers can be used, for example an alloy of bisphenol A polycarbonate with an ester such as poly(butylene terephthalate) or poly(ethylene terephthalate), each of which can be semicrystalline or amorphous. Such combinations are commercially available under the trade name XENOY and XYLEX from SABIC.

A specific copolycarbonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade designation LEXAN XHT from SABIC), a copolymer comprising bisphenol A carbonate units and 1,1-bis(4-hydroxy-3-methylphenyl)cyclohexane carbonate units (a BPA-DMBPC copolymer commercially available under the trade designation LEXAN DMC from SABIC, or a copolymer comprising bisphenol A carbonate units and isophorone bisphenol carbonate units (commercially available under the trade name APEC from Bayer). A combination of linear polycarbonate and a branched polycarbonate can be used. Moreover, combinations of any of the above materials may be used.

The polycarbonates can have an intrinsic viscosity, as determined in chloroform at 25° C., of 0.3 to 1.5 deciliters per gram (dl/gm), specifically 0.45 to 1.0 dl/gm. The polycarbonates can have a weight average molecular weight of 10,000 to 200,000 Daltons, specifically 20,000 to 100,000 Daltons, as measured by gel permeation chromatography (GPC), using a crosslinked styrene-divinylbenzene column and calibrated to polycarbonate references. GPC samples are prepared at a concentration of 1 mg per ml, and are eluted at a flow rate of 1.5 ml per minute.

In some embodiments, the optically clear polymer film can include a polyester (e.g., polyethylene terephthalates, polybutylene terephthalates, polyarylates, and polyester copolymers such as polyester-ethers). In some embodiments, the polyester can include a poly(ethylene terephthalate), a glycol-modified poly(ethylene terephthalate), a poly(ethylene naphthalate), poly(1,4-cyclohexane-dimethanol-1,4-cyclohexane dicarboxylate), poly(cyclohexanedimethylene terephthalate)-co-poly(ethylene terephthalate), or a combination comprising at least one of the foregoing polyesters.

In some embodiments, the optically clear polymer film can include a polyolefin. Representative examples of polyolefins as thermoplastic polymers are polyethylene, polypropylene, polybutylene, polymethylpentene (and co-polymers thereof), polynorbornene (and co-polymers thereof), poly(1-butene), poly(3-methylbutene), poly(4-methylpentene) and copolymers of ethylene with propylene, 1-butene, 1-hexene, 1-octene, 1-decene, 4-methyl-1-pentene and 1-octadecene. Representative combinations of polyolefins are combinations containing polyethylene and polypropylene, low-density polyethylene and high-density polyethylene, and polyethylene and olefin copolymers containing copolymerizable monomers, some of which are described above, e.g., ethylene and acrylic acid copolymers; ethyl and methyl acrylate copolymers; ethylene and ethyl acrylate copolymers; ethylene and vinyl acetate copolymers, ethylene, acrylic acid, and ethyl acrylate copolymers, and ethylene, acrylic acid, and vinyl acetate copolymers. In some embodiments, the thermoplastic polymer can include a polyolefin elastomer.

In some embodiments, the optically clear polymer film can include a vinyl polymer, for example, polyvinyl alcohols, polyvinyl esters, polyvinyl ethers, polyvinyl halides (e.g., polyvinyl fluoride), polyvinyl nitriles, polyvinyl ketones, polyvinyl thioethers, or a combination comprising at least one of the foregoing. In some embodiments, the optically clear polymer film can include a styrenic polymer, for example polystyrene and copolymers thereof including acrylonitrile-butadiene-styrene (ABS) and methyl methacrylate-butadiene-styrene (MBS).

In some embodiments, one or both surfaces of the polymer film can have a textured surface, which can provide, for example, anti-glare properties, anti-reflective properties, anti-microbial properties, and the like, or a combination comprising at least one of the foregoing.

The polymer film of the smart glass-polymer assembly can be prepared using any method for preparing a polymer film that is generally known. For example, the polymer film can be prepared by extrusion, solution casting, melt blowing, and the like. The adhesive can be applied using any suitable process including, but not limited to, roll lamination, roller coating, screen printing, spreading, spray coating, spin coating, dip coating, and the like, or a combination comprising at least one of the foregoing techniques.

In some embodiments, the optically clear polymer film is a multilayer polymer film comprising two or more optically clear polymer layers which can be disposed on, adhered via and adhesive, or otherwise joined, for example laminated, to provide the multilayer film. Each layer of the optically clear polymer film can comprise the same or a different polymer.

As shown in FIG. 1, the second surface of the optically clear polymer film has disposed thereon one or more smart functionalities. In an embodiment wherein the optically clear polymer film comprises multiple layers, one or more smart functionalities can be disposed on each of the layers, or the one or more functionalities can all be disposed on the same layer. Thus, at least two of the optically clear polymer layers can comprise a smart functionality.

As used herein, a smart functionality is a general term that encompasses a composition, article, or a component of an article that contributes to the smart functionality. For example, the functionality can be an electrochromic material, layer, or device, a thermochromic material, layer, or device, a display material, layer, or device component (e.g., a screen or a wire), a light emitting diode, a photovoltaic material, layer, or device, a transparent conductive material, layer, or device, a communication antenna, or a sensing material, layer, or device. Electrochromic functionalities can change light transmission properties in response to voltage, heat, or light, for example. Display functionalities include liquid crystals, for example, thermotropic liquid crystals that change light transmission properties in response to temperature. The smart functionality can have any suitable dimension, but is generally as thin as possible, for example having a thickest dimensions of 1 nanometer to 20 millimeters, or 10 nanometers to 10 millimeters, or 100 nanometers to 1 millimeters, or 1 micrometer to 500 micrometer.

In addition, the second surface of the optically clear polymer film optionally comprises wiring for the smart functionalities.

An optically clear adhesive layer is disposed between the first surface of the glass layer and the second surface of the optically clear polymer film. The optically clear adhesive layer is disposed on at least a portion of the smart functionality and the second surface of the optically clear polymer film. The adhesive also functions as a planarization coating to provide a flat surface onto which the glass layer is deposited, for example laminated. An optically clear adhesive is defined herein as an adhesive wherein a 50 micrometer-thick sample of the optically clear adhesive transmits greater than 85% of visible light as determined according to ASTM D1003-00. In some embodiments, the optically clear adhesive layer is in adhesive contact with the entire first surface of the glass layer. The optically clear adhesive layer can have a thickness of 1 to 2000 micrometers, or 1 to 1000 micrometers, or 1 to 500 micrometers, or 1 to 100 micrometers, or 10 to 100 micrometers, or 10 to 50 micrometers, or 12.5 to 25 micrometers.

The adhesive can include epoxy, acrylate, amine, urethane, silicone, thermoplastic urethane, ethyl vinyl acetate, hindered amine light stabilizer free ethyl vinyl acetate (HALS free EVA), or a combination comprising at least one of the foregoing. In an embodiment, the adhesive is a hindered amine light stabilizer free ethyl vinyl acetate (HALS free EVA). In an embodiment the adhesive is a thermoplastic urethane, or an ultra violet light cured modified acrylate optical quality adhesive, or a silicone pressure sensitive adhesive, or an acrylate pressure sensitive adhesive. The adhesive can be applied using a process such as roll lamination, roller coating, screen printing, spreading, spray coating, spin coating, dip coating, and the like, or a combination comprising at least one of the foregoing techniques.

A glass layer is disposed on the side of the adhesive layer opposite the optically clear polymer film. The glass layer effectively acts as an encapsulant for the smart functionalities, protecting them from gas and moisture, for example. In smart window applications, the surface of the glass that is not contacted by the adhesive can be the inner surface of the window, that is, the surface exposed to the interior of a building, vehicle, or the like, which enables interaction with humans. The glass layer can be, but is not limited to, chemically strengthened glass (e.g., CORNING™ GORILLA™ Glass commercially available from Corning Inc., XENSATION™ glass commercially available from Schott AG, DRAGONTRAIL™ glass commercially available from Asahi Glass Company, LTD, and CX-01 glass commercially available from Nippon Electric Glass Company, LTD, and the like), non-strengthened glass such as non-hardened glass including low sodium glass (e.g., CORNING™ WILLOW™ Glass commercially available from Corning Inc. and OA-10G Glass-on-Roll glass commercially available from Nippon Electric Glass Company, LTD, and the like), tempered glass, or optically transparent synthetic crystal (also referred to as sapphire glass, commercially available from GT Advanced Technologies Inc.).

The glass layer can have a thickness suitable for its intended use, for example 50 micrometers to 20 millimeter, or 50 micrometers to 1.0 millimeter, or 50 to 700 micrometers, or 50 to 400 micrometers.

In some embodiments, one or both surfaces of the glass layer can be a textured surface, which can provide, for example, anti-glare properties, anti-reflective properties, anti-microbial properties, and the like, or a combination comprising at least one of the foregoing.

Optionally, an optically clear coating is present on at least a portion of the surface of the glass layer opposite the adhesive layer. In certain smart window applications, for example, the surface of the glass opposite the adhesive layer is on the inside of the building. The method can further comprise applying the optically clear coating to the desired portion of the second surface of the glass layer. The applying can be by, for example, roll lamination, roller coating, screen printing, spreading, spray coating, spin coating, dip coating, and the like, or a combination comprising at least one of the foregoing techniques. In some embodiments, a film of the optically clear coating can be prepared and subsequently laminated to the desired portion of the cover assembly.

In certain embodiments, the optically clear polymer film, the one or more smart functionalities, the optically clear adhesive layer and the glass layer are flexible. In these embodiments the laminate can be provided in the form of a roll. The roll can comprise, for example multiple smart windows which can be cut from the roll.

As shown in FIG. 1, an optically clear support layer can optionally be disposed on the first surface of the optically clear polymer film. The support layer can comprises any material that provides the intended functionality, for example a glass, a thermoset polymer, or a thermoplastic polymer such as the thermoplastic polymers disclosed herein. In some embodiments the optically clear support layer is selected to be a strong layer that can provide structural rigidity and an enhanced moisture and gas barrier to the smart glass. This feature can be particularly important for window applications. As used herein an optically clear support layer is a layer wherein at thickness of the intended use, the layer transmits greater than 85% of visible light as determined according to ASTM D1003-00; or a 100 micrometer-thick sample of the optically clear support layer transmits greater than 85% of visible light as determined according to ASTM D1003-00.

The optically clear support layer can have a thickness suitable for its intended use, for example 50 micrometers to 20 millimeter, or 50 micrometers to 1.0 millimeter, or 50 to 700 micrometers, or 50 to 400 micrometers. The optically clear support layer can be supplied as a sheet, for example, or a pre-cut form.

A method of manufacturing a smart glass-polymer assembly comprises providing an optically clear polymer film having a first surface and a second surface; disposing a smart functionality and optionally wiring for the smart functionality onto the second surface of the optically clear polymer film; disposing the optically clear adhesive layer onto at least a portion of the smart functionality and the second surface of the optically clear polymer film; disposing the glass layer onto the second side of the optically clear adhesive layer; and optionally disposing an optically clear support layer onto the first surface of the optically clear polymer film, wherein at least one of the foregoing steps is performed in a roll-to-roll process. The method optionally further comprises forming an individual assembly from the roll by cutting, for example laser cutting. An overmolding can be formed, for example injection molded, around an one or all of the edges of the smart window surface to provide a frame and to make the smart window ready for assembly. The overmolding can be a housing to host the driver electronics for the smart window.

In an embodiment, when the optically transparent polymer film comprises a multilayer film, the multilayer film can be manufactured by adhering, for example laminating, two or more optically clear polymer layers, wherein each optically clear polymer layer comprises the same or a different thermoplastic polymer. Roll lamination, such as in a roll-to roll (R2R) process can be used to laminate the polymer film layers. Optionally, two or more layers of the multilayer film comprise one or more smart functionalities. Thus in one embodiment, the method comprises depositing a first smart functionality onto a first optically clear polymer layer; laminating a second optically clear polymer layer onto a side of the first optically clear polymer layer, preferably wherein the laminating is roll to roll laminating; and depositing a second functionality onto a side of the second optically clear polymer layer opposite the first optically clear polymer layer. In another embodiment, the method comprises depositing a first smart functionality onto a first optically clear polymer layer and depositing a second functionality onto the first optically clear polymer layer; and laminating the first optically clear polymer layer to a second optically clear polymer layer, preferably wherein the laminating is roll to roll laminating

Disposing one or more smart functionalities and optionally wiring for the one or more smart functionalities onto the second surface of the optically clear polymer film can be performed by printing, e.g., inkjet printing, screen printing or 3D printing, or by coating using, for example, a roll lamination or roller coating process, such as an R2R process.

Disposing the optically clear adhesive layer onto the second surface of the optically clear polymer film can be performed using, for example, roll lamination such as an R2R process, roller coating, screen printing, spreading, spray coating, spin coating, dip coating, and the like, or a combination comprising at least one of the foregoing techniques.

Applying a glass layer onto the second surface of the optically clear adhesive layer opposite the optically transparent polymer film can comprise a roll lamination or roller coating process, such as an R2R process.

In certain embodiments, one or more of disposing one or more smart functionalities, disposing the optically clear adhesive layer onto the second surface of the optically clear polymer film, or disposing the glass layer onto the second surface of the optically clear adhesive layer opposite the optically transparent polymer film is performed using a roll to roll process.

In some embodiments the optically clear support layer is disposed on the optically clear polymer film before addition of the functionalities, or after the composite is assembled. Alternatively, the optically clear support layer can be adhered to the film via an adhesive. In an embodiment, the optically clear support layer is supplied as a sheet, and laminated to the composite, preferably wherein the composite is in roll form. Applying the optically clear support layer onto the first surface of the optically clear polymer film can comprise a roll to sheet (R2S) process, in which a thick glass or polycarbonate sheet, for example, is laminated onto the glass-polymer laminate. In smart window applications, the support layer can form the outer surface of the window, facing the external environment.

The smart glass-polymer composites can be used for a wide variety of applications, including smart windows. In an aspect, the method comprises removing a portion of the smart glass-polymer assembly and applying an overmolding around the outer edges of the smart glass-polymer assembly to provide a smart window, wherein the overmolding optionally comprises driver electronics for the smart functionalities. Removing at least a portion of the smart glass-polymer assembly can be performed using a laser, for example. An overmolding is optionally injection molded around the edges of the smart window surface to provide a frame and to make the smart window ready for assembly. The overmolding can be a housing to host the driver electronics for the smart window. The windows can be used in a variety of applications, for example buildings (in either internal rooms or rooms exposed to the environment), vehicles (including cars, buses, trains, and the like), watercraft (e.g., ships or submarines), and appliances (e.g., refrigerators, medical treatment devices, and the like).

This disclosure further encompasses the following non-limiting embodiments.

### Embodiment 1

A method of manufacturing a smart glass-polymer assembly (10), the method comprising providing an optically clear polymer film (12) comprising a thermoplastic polymer, and further comprising a first surface (14) and a second surface (16) opposite the first surface; disposing a smart functionality (18) and optionally wiring for the smart functionality (119) onto the second surface (16) of the optically clear polymer film (12); disposing a first side (22) of an optically clear adhesive layer (20) onto at least a portion of the smart functionality (18) and the second surface of the optically clear polymer film (16); and disposing a glass layer (26) onto a second side (24) of the optically clear adhesive layer (20) opposite the first side (22) of the optically clear adhesive layer; wherein at least one of the disposing steps is by roll-to-roll lamination.

### Embodiment 2

The method of claim 1, wherein all of the disposing steps are by roll-to-roll lamination.

### Embodiment 3

The method of claim 1 or claim 2, further comprising disposing an optically clear support layer (32) onto the first surface (14) of the optically clear polymer film (12).

### Embodiment 4

The method of claim 3, wherein disposing the optically clear support layer comprises laminating.

### Embodiment 5

The method of any one or more of claims 1 to 4, wherein the optically clear polymer film comprises a multilayer film comprising two or more optically clear polymer layers, optionally wherein each optically clear polymer layer comprises the same thermoplastic polymer.

### Embodiment 6

The method of claim 5, wherein two or more layers of the multilayer film each comprise a smart functionality.

### Embodiment 7

The method of claim 5 or claim 6, comprising depositing a first smart functionality onto a first optically clear polymer layer; laminating a second optically clear polymer layer onto a side of the first optically clear polymer layer, preferably wherein the laminating is roll to roll laminating; and depositing a second functionality onto a side of the second optically clear polymer layer opposite the first optically clear polymer layer.

### Embodiment 8

The method of claim 5 or 6, comprising depositing a first smart functionality onto a first optically clear polymer layer and depositing a second functionality onto the first optically clear polymer layer; and laminating the first optically clear polymer layer to a second optically clear polymer layer, preferably wherein the laminating is roll to roll laminating.

### Embodiment 9

The method of any one or more of claims 1 to 8, wherein the one or more smart functionalities comprises an electrochromic functionality, a thermochromic functionality, a display functionality, a light emitting diode functionality, a photovoltaic functionality, a transparent conductive functionality, a communication antenna, a sensing functionality, or a combination comprising at least one of the foregoing.

### Embodiment 10

The method of any one or more of claims 1 to 9, wherein a 100 micrometer-thick sample of the optically clear polymer film transmits greater than 85% of visible light as determined according to ASTM D1003-00; or a 50 micrometer-thick sample of the optically clear adhesive transmits greater than 85% of visible light as determined according to ASTM D1003-00; or a 100 micrometer-thick sample of the optically clear glass layer transmits greater than 85% of visible light as determined according to ASTM D1003-00; or a 100 micrometer-thick sample of the optically clear support layer transmits greater than 85% of visible light as determined according to ASTM D1003-00.

### Embodiment 11

The method of any one or more of claims 1 to 10, further comprising applying an overmolding on an outer edge of the smart glass-polymer assembly, wherein the overmolding optionally comprises a driver electronic device for the smart functionalities.

### Embodiment 12

A smart glass-polymer assembly, comprising an optically clear polymer film (12) comprising a thermoplastic polymer, and further comprising first surface (14) and a second surface (16) opposite the first surface; a smart functionality (18) disposed on the second surface (16) of the optically clear polymer film (12), optionally further comprising wiring (119) for the smart functionality (18); an optically clear adhesive layer (20) comprising a first side (22) and a second side (24), wherein the first side (22) is disposed on at least a portion of the smart functionality (18) and the second surface (16) of the optically clear polymer film (12); and a glass layer (26) disposed on the second side (24) of the optically clear adhesive layer (20).

### Embodiment 13

The smart glass-polymer assembly of claim 12, wherein the smart glass-polymer assembly is in the form of a roll.

### Embodiment 14

The smart glass-polymer assembly of claim 12 or 13, further comprising an optically clear support layer (32) disposed on the first surface (14) of the optically clear polymer film (12).

### Embodiment 15

The smart glass-polymer assembly of any one or more of claims 12 to 14, wherein the optically clear polymer film is a multilayer film comprising two or more optically clear polymer layers, optionally wherein each optically clear polymer layer comprises the same thermoplastic polymer.

### Embodiment 16

The smart glass-polymer assembly of claim 15, wherein at least two of the optically clear polymer layers comprise a smart functionality.

### Embodiment 17

The smart glass-polymer assembly of any one or more of claims 12 to 16, wherein the smart functionality comprises an electrochromic functionality, a thermochromic functionality, a display functionality, a light emitting diode functionality, a photovoltaic functionality, a transparent conductive functionality, a communication antenna, a sensing functionality, or a combination comprising at least one of the foregoing.

### Embodiment 18

The smart glass-polymer assembly of any one or more of claims 12 to 17, further comprising an overmolding (24) on an outer edge of the smart glass-polymer assembly (10), wherein the overmolding optionally comprises a driver electronic device for the smart functionality.

### Embodiment 19

A smart window comprising the smart glass-polymer assembly manufactured by the method of any one or more of claims 1 to 11, or the smart glass-polymer assembly of any one or more of claims 1 to 18.

### Embodiment 20

The smart window of claim 19, further comprising an overmolding around an edge of the smart glass-polymer assembly, wherein the overmolding optionally comprises a driver electronic device for the smart functionality.

The assemblies, methods, and devices can alternatively comprise, consist of, or consist essentially of, any appropriate components or steps herein disclosed. The assemblies, methods, and devices can additionally, or alternatively, be manufactured so as to be devoid, or substantially free, of any steps, components, materials, ingredients, adjuvants, or species that are otherwise not necessary to the achievement of the function or objectives of the assemblies, methods, and devices.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃-)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl) a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of manufacturing a smart glass-polymer assembly (10), the method comprising
providing an optically clear polymer film (12) comprising a thermoplastic polymer, and further comprising a first surface (14) and a second surface (16) opposite the first surface;
disposing a smart functionality (18) and optionally wiring for the smart functionality (119) onto the second surface (16) of the optically clear polymer film (12);
disposing a first side (22) of an optically clear adhesive layer (20) onto at least a portion of the smart functionality (18) and the second surface of the optically clear polymer film (16); and
disposing a glass layer (26) onto a second side (24) of the optically clear adhesive layer (20) opposite the first side (22) of the optically clear adhesive layer;
wherein at least one of the disposing steps is by roll-to-roll lamination.

2. The method of claim 1, wherein all of the disposing steps are by roll-to-roll lamination.

3. The method of claim 1, further comprising disposing an optically clear support layer (32) onto the first surface (14) of the optically clear polymer film (12).

4. The method of claim 3, wherein disposing the optically clear support layer comprises laminating.

5. The method of claim 1, wherein the optically clear polymer film comprises a multilayer film comprising two or more optically clear polymer layers, optionally wherein each optically clear polymer layer comprises the same thermoplastic polymer.

6. The method of claim 5, wherein two or more layers of the multilayer film each comprise a smart functionality.

7. The method of claim 5, comprising
depositing a first smart functionality onto a first optically clear polymer layer;
laminating a second optically clear polymer layer onto a side of the first optically clear polymer layer; and
depositing a second functionality onto a side of the second optically clear polymer layer opposite the first optically clear polymer layer.

8. The method of claim 5, comprising
depositing a first smart functionality onto a first optically clear polymer layer and depositing a second functionality onto the first optically clear polymer layer; and
laminating the first optically clear polymer layer to a second optically clear polymer layer.

9. The method of claim 1, wherein the one or more smart functionalities comprises an electrochromic functionality, a thermochromic functionality, a display functionality, a light emitting diode functionality, a photovoltaic functionality, a transparent conductive functionality, a communication antenna, a sensing functionality, or a combination comprising at least one of the foregoing.

10. The method of claim 1, wherein
a 100 micrometer-thick sample of the optically clear polymer film transmits greater than 85% of visible light as determined according to ASTM D1003-00; or
a 50 micrometer-thick sample of the optically clear adhesive transmits greater than 85% of visible light as determined according to ASTM D1003-00; or
a 100 micrometer-thick sample of the optically clear support layer transmits greater than 85% of visible light as determined according to ASTM D1003-00.

11. The method of claim 1, further comprising applying an overmolding on an outer edge of the smart glass-polymer assembly, wherein the overmolding optionally comprises a driver electronic device for the smart functionalities.

12. A smart glass-polymer assembly, comprising
an optically clear polymer film (12) comprising a thermoplastic polymer, and further comprising first surface (14) and a second surface (16) opposite the first surface;
a smart functionality (18) disposed on the second surface (16) of the optically clear polymer film (12), optionally further comprising wiring (119) for the smart functionality (18);
an optically clear adhesive layer (20) comprising a first side (22) and a second side (24), wherein the first side (22) is disposed on at least a portion of the smart functionality (18) and the second surface (16) of the optically clear polymer film (12); and
a glass layer (26) disposed on the second side (24) of the optically clear adhesive layer (20).

13. The smart glass-polymer assembly of claim 12, wherein the smart glass-polymer assembly is in the form of a roll.

14. The smart glass-polymer assembly of claim 12, further comprising an optically clear support layer (32) disposed on the first surface (14) of the optically clear polymer film (12).

15. The smart glass-polymer assembly of claim 12, wherein the optically clear polymer film is a multilayer film comprising two or more optically clear polymer layers, optionally wherein each optically clear polymer layer comprises the same thermoplastic polymer.

16. The smart glass-polymer assembly of claim 15, wherein at least two of the optically clear polymer layers comprise a smart functionality.

17. The smart glass-polymer assembly of claim 12, wherein the smart functionality comprises an electrochromic functionality, a thermochromic functionality, a display functionality, a light emitting diode functionality, a photovoltaic functionality, a transparent conductive functionality, a communication antenna, a sensing functionality, or a combination comprising at least one of the foregoing.

18. The smart glass-polymer assembly of claim 12, further comprising an overmolding (24) on an outer edge of the smart glass-polymer assembly (10), wherein the overmolding optionally comprises a driver electronic device for the smart functionality.

19. A smart window comprising the smart glass-polymer assembly manufactured by the method of claim 1, or the smart glass-polymer assembly of claim 1.

20. The smart window of claim 19, further comprising an overmolding around an edge of the smart glass-polymer assembly, wherein the overmolding optionally comprises a driver electronic device for the smart functionality.
